(19) United States
(12) Patent Application Publication
(10) Pub. No.: US 2019/0388851 A1
(43) Pub. Date: Dec. 26, 2019

(54) LARGE ENGINE MIXER FOR EXHAUST SYSTEM

(71) Applicant: Faurecia Systemes D'echappement, Nanterre (FR)

(72) Inventor: Julien Moulieres, Montbeliard (FR)

(21) Appl. No.: 16/016,859

(22) Filed: Jun. 25, 2018

(51) Int. Cl. B01F 5/04; F01N 3/28; F01N 3/20

(52) U.S. Cl. CPC B01F 5/0451; F01N 3/2892; F01N 2610/08; F01N 2240/20; F01N 2610/02; F01N 3/208

(57) ABSTRACT

A vehicle exhaust system includes an upstream exhaust component, an intermediate exhaust component, and a downstream exhaust component. The upstream exhaust component is defined by a first outermost diameter and the downstream exhaust component is defined by a second outermost diameter. The intermediate exhaust component is positioned between the upstream and downstream exhaust components and is defined by a third outermost diameter that is greater than the first and second outermost diameters. At least one mixer is located in at least one of the upstream exhaust component, downstream exhaust component, or intermediate exhaust component. An injector is configured to inject fluid into the intermediate exhaust component.

### TECHNICAL FIELD

This invention generally relates to a vehicle exhaust system that provides an enlarged area between mixing elements in which to inject a fluid to mix with exhaust gases.

### BACKGROUND OF THE INVENTION

An exhaust system conducts hot exhaust gases generated by an engine through various exhaust components to reduce emissions and control noise. The exhaust system includes an injection system that injects a diesel exhaust fluid (DEF) such as AdBlue®, or any reducing agent or fluid that is a solution of urea and water for example, upstream of a selective catalytic reduction (SCR) catalyst. The injection system includes a doser or injector that sprays the injected fluid into the exhaust stream. The urea from the injected fluid should be transformed as much as possible into ammonia (NH₃) before reaching the SCR catalyst.

The industry is moving towards providing more compact exhaust systems, which results in reduced volume of the system. However, large engines produce significant amounts of NOx, and as a result, it is necessary to inject a large amount of fluid into the exhaust gas stream. When large amounts of fluid are injected into the exhaust stream it has a cooling effect and can result in fast cooling along the walls of the injection location. Further, the injection force can direct the fluid toward a certain location on the walls to form an impingement area. The fast cooling along the walls and at the impingement area can lead to urea deposit formation at these locations which can adversely affect system performance.

Insulation can be used to maintain higher temperatures along the walls; however, for large engines the insulation is not sufficient on its own to maintain a sufficient temperature level. There is a need to find a solution to limit impingement of fluid spray on the walls or to direct spray to an area where the risk of deposit formation is low.

### SUMMARY OF THE INVENTION

In one exemplary embodiment, a vehicle exhaust system includes an upstream exhaust component, an intermediate exhaust component, and a downstream exhaust component. The upstream exhaust component is defined by a first outermost diameter and the downstream exhaust component is defined by a second outermost diameter. The intermediate exhaust component is positioned between the upstream and downstream exhaust components and is defined by a third outermost diameter that is greater than the first and second outermost diameters. At least one mixer is located in at least one of the upstream exhaust component, downstream exhaust component, or intermediate exhaust component. An injector is configured to inject fluid into the intermediate exhaust component.

In a further embodiment of the above, the intermediate exhaust component comprises an inlet cone, an outlet cone, and a center portion that connects the inlet and outlet cones, and wherein the center portion defines the third outermost diameter.

In another exemplary embodiment, a vehicle exhaust system includes an upstream exhaust component defining a center axis and a downstream exhaust component that is coaxial with the upstream exhaust component. An intermediate exhaust component has a first end connected to an outlet from the upstream exhaust component and a second end connected to an inlet to the downstream exhaust component. The intermediate exhaust component is defined by an outermost diameter that is greater than the outermost diameters of the upstream and downstream exhaust components. At least one mixer is located in at least one of the upstream exhaust component, downstream exhaust component, or intermediate exhaust component. An injector is configured to inject fluid into the intermediate exhaust component.

In a further embodiment of any of the above, the at least one mixer comprises at least a first mixer in the upstream exhaust component and a second mixer in the downstream exhaust component.

In a further embodiment of any of the above, the first mixer comprises a helix mixer to generate a single swirling flow or a multi-plate mixer to generate a double swirling flow.

In a further embodiment of any of the above, the second mixer comprises a plate that is inclined relative to a center axis of the downstream exhaust component or a multi-plate mixer to generate a double swirling flow.

In another exemplary embodiment, a method of injecting fluid into a vehicle exhaust system comprises: providing an upstream exhaust component defined by a first outermost diameter and a downstream exhaust component defined by a second outermost diameter; connecting one end of an intermediate exhaust component to the upstream exhaust component and an opposite end of the intermediate exhaust component to the downstream exhaust component, the intermediate exhaust component being defined by a third outermost diameter that is greater than the first and second outermost diameters; generating a swirling flow of exhaust gas in the upstream exhaust component, downstream exhaust component, or intermediate exhaust component with at least one mixer; injecting fluid into the intermediate exhaust component to mix with the exhaust gas; and providing an outlet flow of a mixture of fluid and the exhaust gas from the downstream exhaust component.

These and other features of the present invention can be best understood from the following specification and drawings, the following of which is a brief description.

### BRIEF DESCRIPTION OF THE DRAWINGS

FIG. 1 is a schematic view of a vehicle exhaust system with a mixer assembly incorporating the subject invention.

FIG. 2 is a schematic view of the mixer assembly of FIG. 1.

FIG. 3 is a schematic view of the mixer assembly of FIG. 2 with example embodiments of mixing elements.

FIG. 4 shows a flow pattern for an upstream mixing element as used in the mixing assembly of FIG. 3.

FIG. 5 shows a flow pattern for a downstream mixing element as used in the mixing assembly of FIG. 3.

FIG. 6 shows another example of a downstream mixing element.

FIG. 7 shows an example of a mixing element as used in a center portion of the mixer assembly.

FIG. 8 shows an example of an upstream deflector.

FIG. 9 shows another example of a mixing element as used in a center portion of the mixer assembly.

FIG. 10 shows an example location for the upstream deflector of FIG. 8.

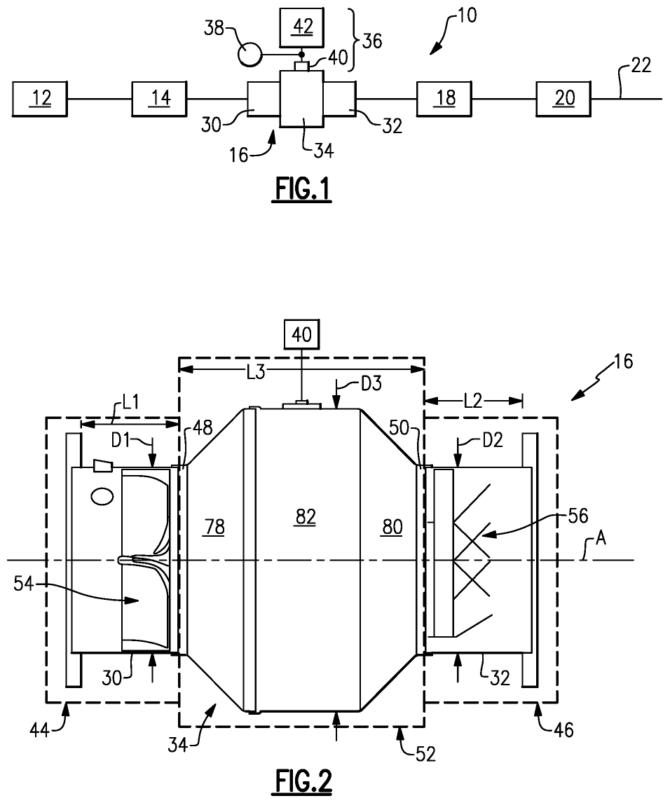

### DETAILED DESCRIPTION

A vehicle exhaust system 10 includes an engine 12 that generates exhaust gases that are conveyed through various upstream exhaust components 14. The upstream exhaust components 14 include components such as particulate filters, catalysts, e.g. SCR, DOC, etc., and other components that remove undesirable elements from the exhaust gases. In one example configuration, the upstream exhaust components 14 include a mixer assembly 16 that is used to direct a mixture of injected fluid and engine exhaust gases into a downstream catalyst substrate 18, such as a SCR substrate for example. In one example, the mixer assembly 16 of the upstream components is located at a turbocharger outlet. Downstream of the substrate 18 there may be various additional downstream exhaust components 20. The various downstream exhaust components 20 can include one or more of the following: pipes, mufflers, resonators, etc., and direct the exhaust gases to an outlet to atmosphere via a tailpipe 22. These upstream 14 and downstream 20 components can be mounted in various different configurations and combinations dependent upon type of application and available packaging space.

The mixer assembly 16 includes an upstream exhaust component 30, a downstream exhaust component 32, and an intermediate component 34 that connects the upstream 30 and downstream 32 exhaust components together. The mixer assembly 16 is used to generate a swirling or rotary motion of the exhaust gas. An injection system 36 is used to inject diesel exhaust fluid (DEF) such as AdBlue®, or any reducing agent or fluid that is a solution of urea and water for example, into the exhaust gas stream such that the mixer assembly 16 can mix the injected fluid and exhaust gas thoroughly together. The injection system 36 includes a fluid supply 38, a doser or an injector 40, and a controller 42 that controls injection of the fluid as known. The doser/injector 40 is a known component and any type of doser/injector 40 can be used to inject the fluid from the fluid supply 38 into the exhaust stream.

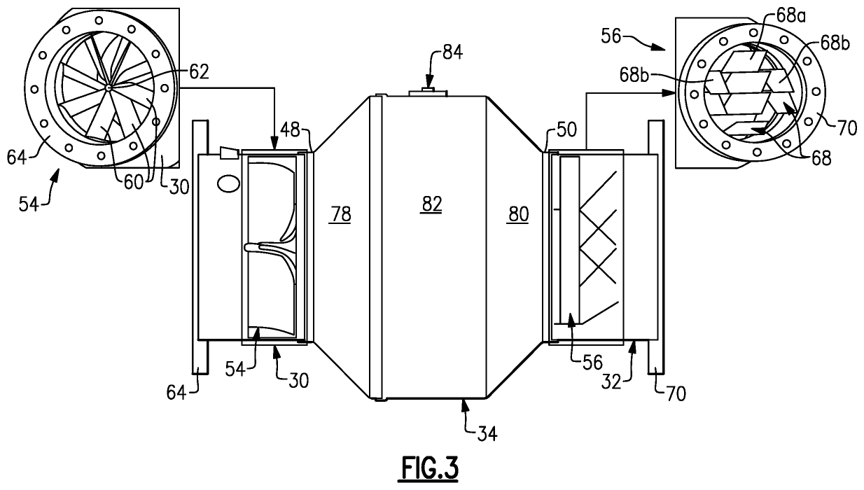

In one example shown in FIG. 2, the upstream 30, downstream 32, and intermediate 34 exhaust components define a center axis A such that the components are all coaxial with each other. In this example, the upstream exhaust component 30 comprises a first pipe that defines an upstream volume 44 and the downstream component 32 comprises a second pipe that defines a downstream volume 46. The intermediate exhaust component 34 has a first end 48 connected to an outlet from the upstream exhaust component 30 and a second end 50 connected to an inlet to the downstream exhaust component 32. The intermediate exhaust component 34 defines an intermediate volume 52 that is larger than the upstream 44 and downstream 46 volumes of the mixer assembly 16.

The upstream exhaust component 30 is defined by a first outermost diameter D1 and the downstream exhaust component 32 is defined by a second outermost diameter D2. The intermediate exhaust component 34 is defined by a third outermost diameter D3 that is greater than the first D1 and second D2 outermost diameters. The upstream exhaust component 30 is defined by a first length L1 and the downstream exhaust component 32 is defined by a second length L2. The intermediate exhaust component 34 is defined by a third length L3 that is greater than the first L1 and second L2 lengths. The longer length L3 and larger diameter D3 of the intermediate exhaust component 34 provides for the larger volume 52 of the intermediate exhaust component 34. The injector 40 is configured to inject fluid into the intermediate exhaust component 34. The increased volume 52 of the intermediate exhaust component 34 provides for more thorough mixing of the injected fluid with the exhaust gas.

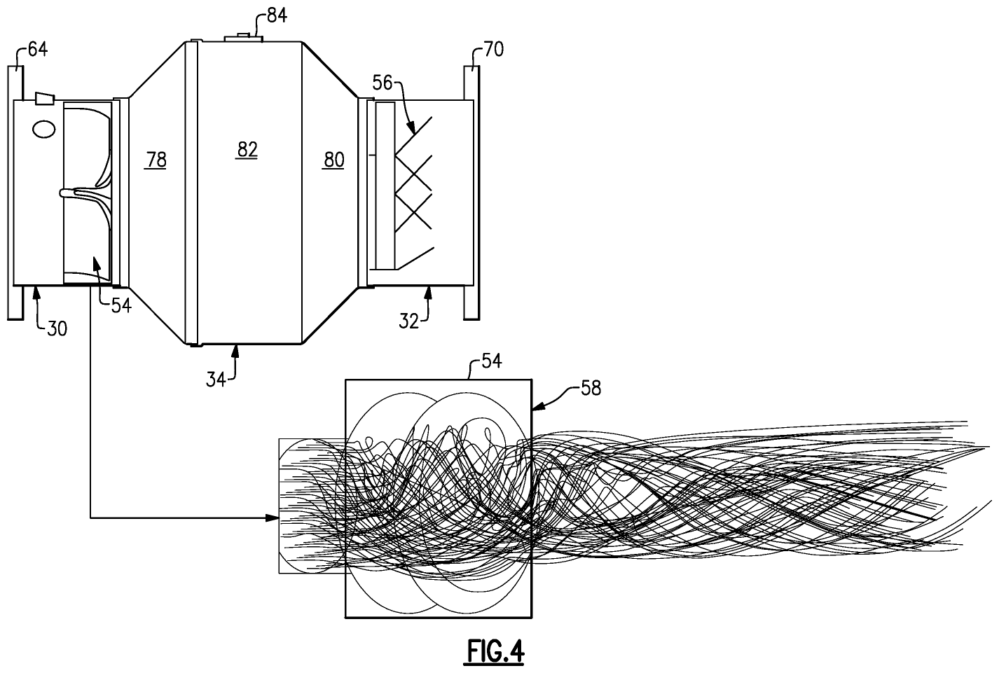

The mixer assembly 16 includes one or more mixing elements that are axially spaced apart from each other along the center axis A. As shown in the example of FIGS. 2-5, the upstream exhaust component 30 includes a first mixer 54 and the downstream exhaust component 32 includes a second mixer 56. Examples of the first 54 and second 56 mixers are shown in FIG. 3. Each of the mixers is used to generate a swirling flow pattern. In this example, the intermediate exhaust component 34 is an open volume that is free from having a mixing element.

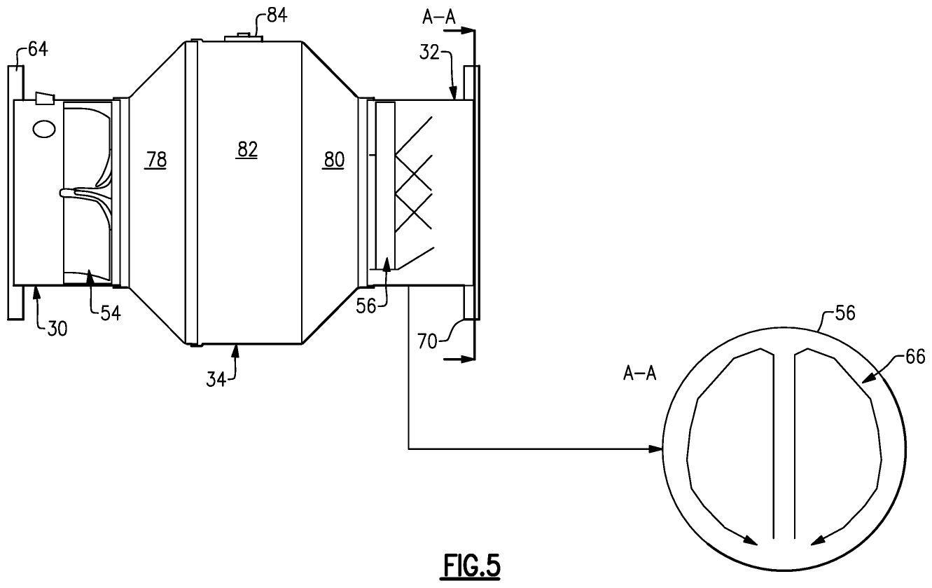

In one example, the first mixer 54 is a helix mixer that generates a single swirling flow pattern 58 as shown in FIG. 4. In this example, the mixer 54 includes a plurality of plates 60 that extend outwardly in a radial direction from the center axis A. The plates 60 can comprise flat or curved surfaces. The plates 60 are circumferentially spaced apart from each other to provide flow gaps between adjacent plates 60. The plates 60 have radially inner ends that are connected to each other or to a center shaft 62 and radially outer ends that are connected to an inner surface of the upstream exhaust component 30. The plates 60 are completely enclosed within the pipe that forms the upstream exhaust component 30. The pipe includes an enlarged connecting flange 64 that connects to further upstream exhaust component, such as a DOC for example.

In one example, the second mixer 56 is a multi-plate mixer that generates a double swirling flow 66 as shown in FIG. 5. In this example, the mixer 56 includes a plurality of plates 68 that are inclined at various different angles relative to the center axis A. In one example, a center set of plates 68a are axially spaced apart from each other across a diameter of the pipe to provide flow gaps between adjacent plates 68a. The center set of plates 68a are inclined at an obtuse angle relative to the center axis A such that downstream edges of the plates 68a extend in an upward direction in FIG. 3. On each opposing side of the center set of plates 68 are a set of smaller plates 68b. The plates 68b are axially spaced apart from each other in the same direction, i.e. vertical direction, as the center set of plates 68a to provide flow gaps between adjacent plates 68b. The plates 68b are inclined at an obtuse angle relative to the center axis A such that downstream edges of the plates 68b extend in a downward direction in FIG. 3. As such the center set of plates 68a and the sets of side plates 68b extend in different directions from each other. The plates 68 are completely enclosed within the pipe that forms the downstream exhaust component 32. The pipe includes an enlarged connecting flange 70 that connects to a further downstream exhaust component, such as a SCR catalyst for example.

In one example, the first mixer 54 comprises the helix mixer that generates the single swirl 58 to increase the amount of exhaust gas close to the inner wall of the intermediate volume 52. The second mixer 56 is preferably a multi-plate mixer that generates the double swirl 66 as the mixing efficiency is higher than a single swirl mixer. Optionally, the first mixer 54 could also be a multi-plate mixer that generates the double swirl 66.

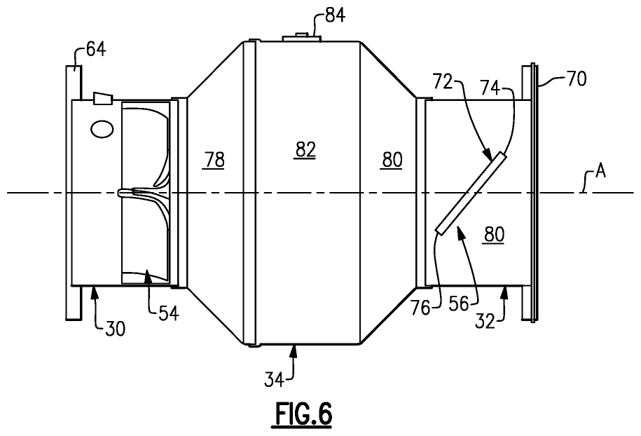

In another example, the second mixer 56 can be a single plate 72 that is inclined relative to the center axis A of the downstream exhaust component 32 as shown in FIG. 6. In this example, the plate 72 is at an obtuse angle relative to the center axis A with a downstream edge 74 being above the axis A and forward of an upstream edge 76, which is below the axis A. This configuration creates more random turbulence rather than a proper swirl pattern. The result of using this configuration is to reduce the pressure drop of the mixer assembly 16 but also to increase the distance necessary to properly mix the injected fluid in with the exhaust gas. Also, the impingement area on the downstream, second mixer 56 is significantly reduced and liquid droplets are allowed to exit the downstream volume 46 of the assembly 16.

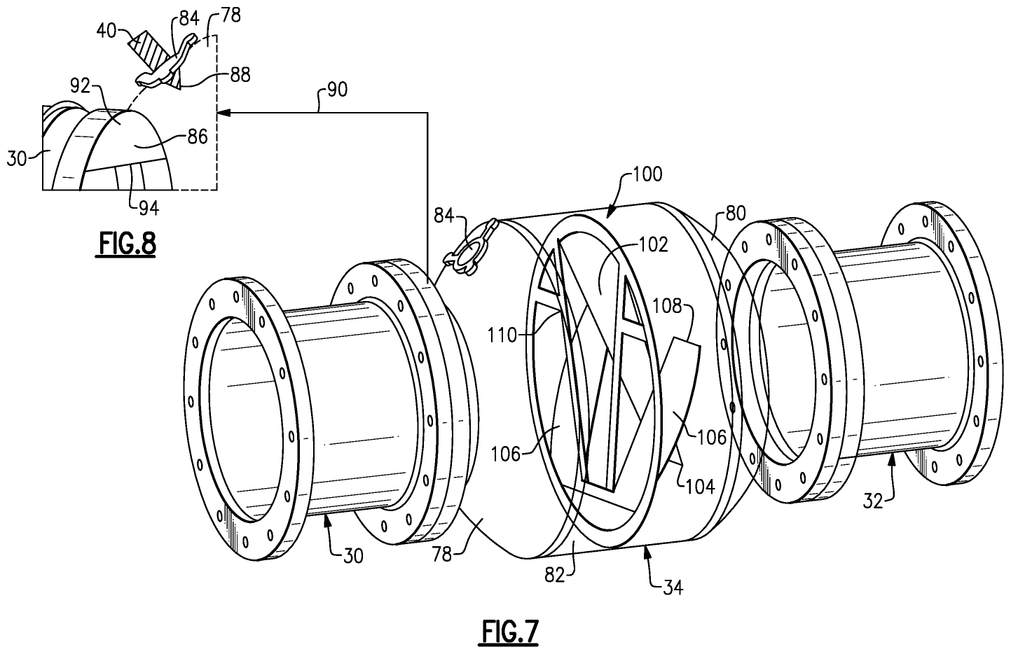

In each configuration, the intermediate exhaust component 34 comprises an inlet cone 78 directly connected to the outlet from the upstream exhaust component 30, an outlet cone 80 directly connected to the inlet to the downstream exhaust component 32, and a center portion 82 that connects the inlet cone 78 and outlet cone 80. The center portion 82 defines the third outermost diameter D3. In the examples shown in FIGS. 2-6, the center portion 82 also includes an injector mount boss 84 that is configured to receive the injector 40. FIGS. 7, 9, and 10 show another example where the inlet cone 78 includes the injector mount boss 84.

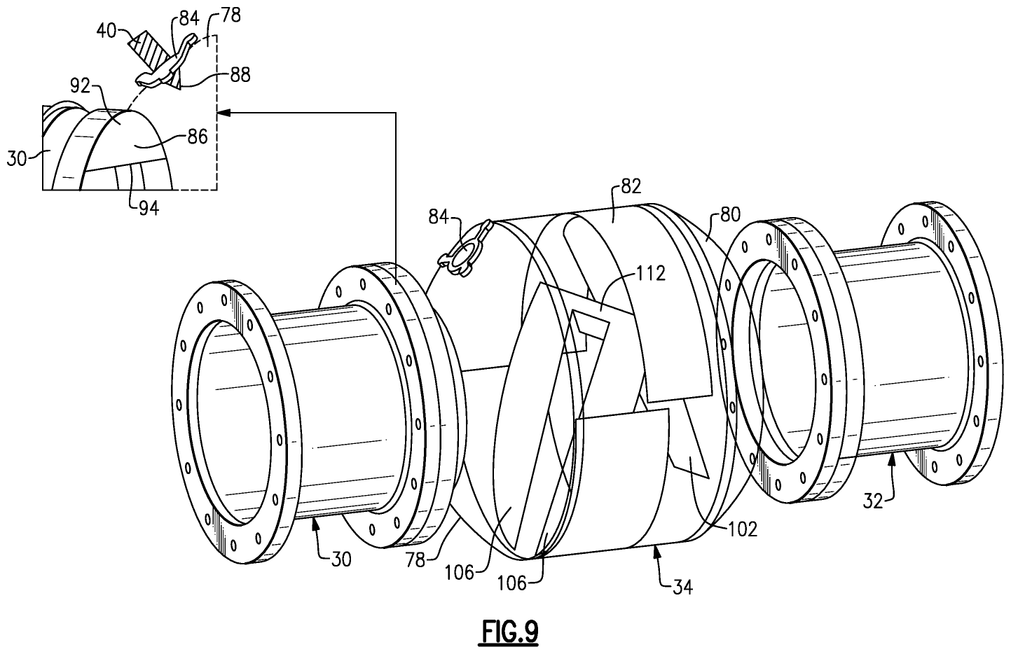

In the configuration shown in FIG. 7, the mixer assembly 16 uses a central mixer 100 and can include a small upstream deflector 86 that isolates an injector tip 88 (FIG. 8) from the main exhaust gas stream S (FIG. 10). The deflector 86 also reduces the impingement on the outer shell of the center portion 82 and the outlet cone 80. Further, the deflector 86 allows for improved control of the behavior of the fluid spray and the impingement area on downstream mixing elements.

In the example shown in FIG. 7, the inlet cone 78 includes the deflector 86 as indicated at 90. As shown in the example of FIG. 8, the deflector 86 comprises a flat plate having the shape of a half circle. A curved portion 92 of the plate matches the curve of an inner surface of the inlet cone 78 at a location that is on the same side of the cone 78 as the mount 84, and the straight edge 94 of the plate is vertically downward of the curved portion 92 and terminates at a location that is above the center axis A. In this example, the deflector 86 is within a vertical plane that is perpendicular to the axis A.

In the example shown in FIG. 10, the deflector 86 extends at an angle relative to the center axis. An upper edge 96 of the deflector 86 is at a location that is on the same side of the cone 78 as the mount 84, and the lower edge 98 of the deflector 86 extends downward and terminates at a location that is above the center axis A. In this example, the deflector 86 is at an obtuse angle relative to the axis A with the lower edge 98 being downstream of the upper edge 96.

In the example of FIG. 7, the center portion 82 includes the central single mixer 100 that is positioned downstream of the injector mount 84. In this example, the mixer 100 includes a single center deflector plate 102 that is inclined at an obtuse angle relative to the center axis A such that a downstream edge 104 of the center deflector plate 102 extends in a downward direction in FIG. 7. On each opposing side of the center deflector plate 102 is a smaller plate 106. Each plate 106 is inclined at an obtuse angle relative to the center axis A such that downstream edges 108 of the plates 106 extend in an upward direction in FIG. 3. The plates 102, 106 are completely enclosed within the center portion 82 of the intermediate exhaust component 34. The plates 106 have a shorter length than the center plate 102 which extends almost across the entire cross-sectional area of the center portion 82. The plates 102, 106 are cut from a flat baffle and are bent to their desired position leaving an open framework 110 through which the exhaust gas and injected fluid can flow and mix together.

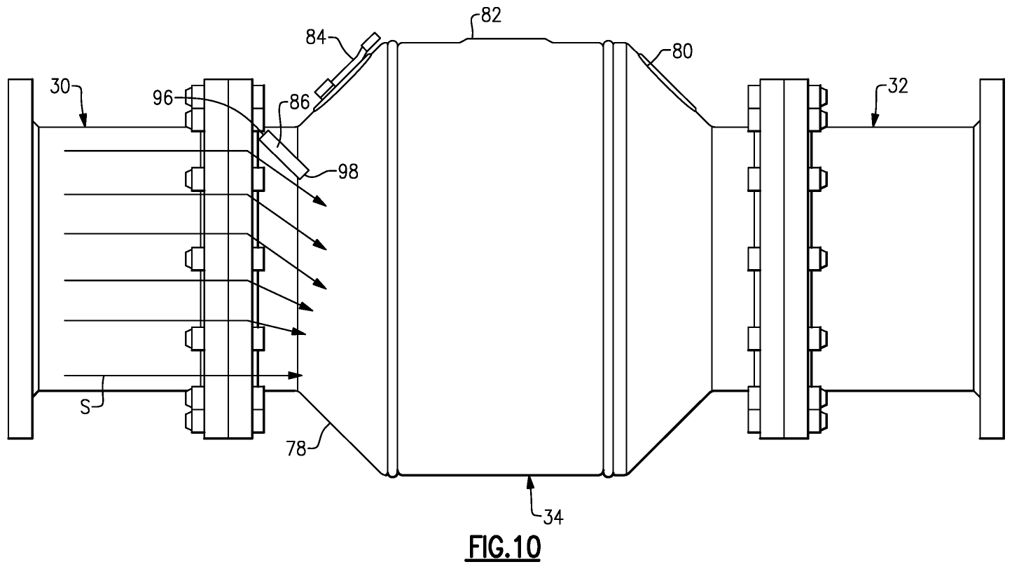

FIG. 9 shows another example of a central single mixer 100. In this example, instead of being cut from a common flat baffle, two separate pieces are used to form the center plate 102 and the side plates 106. This configuration is easier to manufacture and weld into the center portion 82 for improved control of the shape after welding. The upper edge of the central plate 102 is fixed to the inner surface of the center portion 82 while the lower edge extends downwardly and forwardly, i.e. in a downstream direction, of the upper edge. The side plates 106 are connected with each other by a bridge 112 to form a U-shape. The lower edges of the side plates 106 extend downwardly and rearward, i.e. in an upstream direction, from the bridge 112 that connects the upper edge of the side plates 106 together.

The subject invention provides an enlarged injection area that provides for increased volume prior to spray impingement. A single central mixer can be used in the enlarged injection area or the enlarged injection area can be positioned between upstream and downstream mixing elements. Further, the injected spray is protected from the main exhaust gas flow to allow for better spray penetration. Additionally, using various types of mixers upstream and downstream of the enlarged injection area provides more efficient mixing over a shortened length.

Although an embodiment of this invention has been disclosed, a worker of ordinary skill in this art would recognize that certain modifications would come within the scope of this invention. For that reason, the following claims should be studied to determine the true scope and content of this invention.

1. A vehicle exhaust system comprising:
an upstream exhaust component defined by a first outermost diameter;
a downstream exhaust component defined by a second outermost diameter;
an intermediate exhaust component positioned between the upstream and downstream exhaust components, the intermediate exhaust component defined by a third outermost diameter that is greater than the first and second outermost diameters;
at least one mixer located in at least one of the upstream exhaust component, downstream exhaust component, or intermediate exhaust component; and
an injector configured to inject fluid into the intermediate exhaust component.

2. The vehicle exhaust system according to claim 1 wherein the upstream exhaust component, downstream exhaust component, and intermediate exhaust component are coaxial.

3. The vehicle exhaust system according to claim 2 wherein the intermediate exhaust component has a first end directly connected to an outlet from the upstream exhaust component and a second end directly connected to an inlet to the downstream exhaust component.

4. The vehicle exhaust system according to claim 1 wherein the intermediate exhaust component comprises an inlet cone, an outlet cone, and a center portion that connects the inlet and outlet cones, and wherein the center portion defines the third outermost diameter.

5. The vehicle exhaust system according to claim 4 wherein the center portion includes the at least one mixer.

6. The vehicle exhaust system according to claim 5 wherein the injector is mounted to the center portion or inlet cone.

7. The vehicle exhaust system according to claim 6 wherein the intermediate exhaust component includes at least one deflector to isolate a tip of the injector from a main exhaust gas flow entering the intermediate exhaust component.

8. The vehicle exhaust system according to claim 1 wherein the at least one mixer comprises at least a first mixer in the upstream exhaust component and a second mixer in the downstream exhaust component, and wherein the first mixer comprises a helix mixer.

9. The vehicle exhaust system according to claim 1 wherein the at least one mixer comprises at least a first mixer in the upstream exhaust component and a second mixer in the downstream exhaust component, and wherein the first mixer comprises a double swirl mixer.

10. The vehicle exhaust system according to claim 1 wherein the at least one mixer comprises at least a first mixer in the upstream exhaust component and a second mixer in the downstream exhaust component, and wherein the second mixer comprises a plate that is inclined relative to a center axis of the downstream exhaust component.

11. The vehicle exhaust system according to claim 1 wherein the at least one mixer comprises at least a first mixer in the upstream exhaust component and a second mixer in the downstream exhaust component, and wherein the second mixer comprises a double swirl mixer.

12. A vehicle exhaust system comprising:
an upstream exhaust component defining a center axis, the upstream exhaust component defined by a first outermost diameter;
a downstream exhaust component coaxial with the upstream exhaust component, the downstream exhaust component defined by a second outermost diameter;
an intermediate exhaust component having a first end connected to an outlet from the upstream exhaust component and a second end connected to an inlet to the downstream exhaust component, the intermediate exhaust component defined by a third outermost diameter that is greater than the first and second outermost diameters;
at least one mixer located in at least one of the upstream exhaust component, downstream exhaust component, or intermediate exhaust component; and
an injector configured to inject fluid into the intermediate exhaust component.

13. The vehicle exhaust system according to claim 12 wherein the at least one mixer comprises at least a first mixer in the upstream exhaust component and a second mixer in the downstream exhaust component, and wherein the intermediate exhaust component includes an inlet cone directly connected to the outlet from the upstream exhaust component, an outlet cone directly connected to the inlet to the downstream exhaust component, and a center portion that connects the inlet cone and outlet cone, and wherein the center portion defines the third outermost diameter.

14. The vehicle exhaust system according to claim 12 wherein the center portion includes the at least one mixer, and wherein the at least one mixer is positioned downstream of the injector.

15. The vehicle exhaust system according to claim 14 wherein the injector is mounted to the inlet cone, and wherein the at least one mixer includes at least one central deflector inclined relative to the center axis and a pair of additional deflectors positioned one on each side of the central deflector and inclined relative to the center axis.

16. The vehicle exhaust system according to claim 15 wherein the intermediate exhaust component includes at least one deflector to isolate a tip of the injector from a main exhaust gas flow entering the intermediate exhaust component.

17. The vehicle exhaust system according to claim 12 wherein the at least one mixer comprises at least a first mixer in the upstream exhaust component and a second mixer in the downstream exhaust component, and wherein the first mixer comprises a helix mixer to generate a single swirling flow or multi-plate mixer to generate a double swirling flow.

18. The vehicle exhaust system according to claim 12 wherein the at least one mixer comprises at least a first mixer in the upstream exhaust component and a second mixer in the downstream exhaust component, and wherein the second mixer comprises a plate that is inclined relative to a center axis of the downstream exhaust component.

19. The vehicle exhaust system according to claim 12 wherein the at least one mixer comprises at least a first mixer in the upstream exhaust component and a second mixer in the downstream exhaust component, and wherein the second mixer comprises a multi-plate mixer to generate a double swirling flow.

20. A method of injecting fluid into a vehicle exhaust system comprising:
providing an upstream exhaust component defined by a first outermost diameter and a downstream exhaust component defined by a second outermost diameter;
connecting one end of an intermediate exhaust component to the upstream exhaust component and an opposite end of the intermediate exhaust component to the downstream exhaust component, the intermediate exhaust component being defined by a third outermost diameter that is greater than the first and second outermost diameters;
generating a swirling flow of exhaust gas in the upstream exhaust component, downstream exhaust component, or intermediate exhaust component with at least one mixer;
injecting fluid into the intermediate exhaust component to mix with the exhaust gas; and
providing an outlet flow of a mixture of fluid and the exhaust gas from the downstream exhaust component.
